(19) United States
(12) Patent Application Publication
(10) Pub. No.: US 2025/0386819 A1
(43) Pub. Date: Dec. 25, 2025

(54) PRE-MEASURED SINGLE USE CONCENTRATED PESTICIDE PRODUCT AND METHOD OF CREATING A PESTICIDE SPRAY THEREFROM

(71) Applicant: Cameron P. Arrowood, Lexington, NC (US)

(72) Inventor: Cameron P. Arrowood, Lexington, NC (US)

(21) Appl. No.: 19/229,742

(22) Filed: Jun. 5, 2025

Related U.S. Application Data
(60) Provisional application No. 63/664,068, filed on Jun. 25, 2024.

(51) Int. Cl. A01M 7/00; A01M 21/04; A01N 25/06; A01N 57/20; A01P 13/00

(52) U.S. Cl. CPC A01M 7/0046; A01M 7/0085; A01M 21/043; A01N 25/06; A01N 57/20; A01P 13/00

(57) ABSTRACT

A pre-measured single use concentrated pesticide product includes a pesticide material in a concentrated form. The pesticide material is in a quantity that is pre-measured for a specific applicator tank size. A bottle is provided that is sized and configured to hold the quantity of the pesticide material that is pre-measured for the specific applicator tank size. The pesticide material is sealed and packaged inside of the bottle. The pre-measured single use concentrated pesticide product is designed and configured to optimize efficiency in mixing the pesticide material in the concentrated form with water in an applicator with the specific applicator tank size.

### CROSS-REFERENCE TO RELATED APPLICATIONS

This application claims benefit to U.S. Provisional Patent Application No. 63/664,068 filed on Jun. 25, 2024, entitled, which is incorporated by reference in its entirety.

### FIELD OF THE DISCLOSURE

The present disclosure relates to pesticides, like herbicides and fungicides. More specifically, the present disclosure relates to a pre-measured single use concentrated pesticide product, like a pre-measured single use concentrated herbicide product (selective or non-selective), or a pre-measured single use fungicide product, and methods of creating a pesticide spray therefrom.

### BACKGROUND

Generally speaking, pesticides substances that are used to control pests. They include herbicides, insecticides, nematicides, fungicides, and many others. The most common of these may be herbicides. Most pesticides are used as plant protection products (also known as crop protection products), which in general protect plants from weeds, fungi, or insects. In general, a pesticide is a chemical or biological agent (such as a virus, bacterium, or fungus) that deters, incapacitates, kills, or otherwise discourages pests. Target pests can include insects, plant pathogens, weeds, molluscs, birds, mammals, fish, nematodes (roundworms), and microbes that destroy property, cause nuisance, spread disease, or are disease vectors.

Herbicides, also commonly known as weed killers, are pesticides used to control undesired plants, also known as weeds. Selective herbicides control specific weed species while leaving the desired crop relatively unharmed, while non-selective herbicides (sometimes called “total weed killers”) kill plants indiscriminately.

Fungicides are pesticides used to kill parasitic fungi or their spores. Fungi can cause serious damage in agriculture, resulting in losses of yield and quality. Fungicides are also used to control oomycetes, which are not taxonomically/genetically fungi, although sharing similar methods of infecting plants. Fungicides can either be contact, translaminar or systemic.

The instant disclosure recognizes the time, effort and difficulty required to measure out the precise amounts of pesticides to be added to typical spraying equipment, including, but not limited to, ½-gallon hand sprayers, 1-gallon hand sprayers, 2-gallon hand sprayers, 4-gallon or 5-gallon backpack sprayers, and/or 30-gallon broadcast sprayers. As an example, for commercial lawn applications, a user has to fill their sprayer with water near a water source, and then add the pesticide once filled. This can lead to time, effort and difficulties of carrying large pesticide containers back and forth to the water source. In addition, the time, effort and difficulty to measure out the precise amounts of pesticide near the water source can be problematic, especially with large containers of pesticides. As such, there is clearly a need to provide a more efficient and easier means and method for adding concentrated pesticides to their application equipment or spraying equipment.

One drawback to pesticides is the toxicity to humans and other species, especially when the pesticides are in their concentrated form, like while being mixed with water for use in a sprayer. Protecting the environment and the users from contamination of pesticides is clearly desired, especially prior to and during the mixing of the concentrated pesticides prior to use. As such, providing a means and method for measuring and mixing pesticides for use that is safer from contamination of the environment and the user is clearly needed.

The instant disclosure may be designed to address at least certain aspects of the problems or needs discussed above by providing a pre-measured single use concentrated pesticide product and method of creating a pesticide spray therefrom.

### SUMMARY

The present disclosure may solve the aforementioned limitations of the currently available pesticide products, by providing the disclosed pre-measured single use concentrated pesticide product and method of creating a pesticide spray therefrom. The pre-measured single use concentrated pesticide product may generally include a pesticide material in a concentrated form. The pesticide material may be in a quantity that is pre-measured for a specific applicator tank size. A bottle may be provided that is sized and configured to hold the quantity of the pesticide material that is pre-measured for the specific applicator tank size. The pesticide material may be sealed and packaged inside of the bottle.

One feature of the disclosed pre-measured single use concentrated pesticide product may be that it can be designed and configured to optimize efficiency in mixing the pesticide material in the concentrated form with water in an applicator with the specific applicator tank size.

Another feature of the disclosed pre-measured single use concentrated pesticide product according may be that it can be designed and configured to create a safer work environment when mixing the pesticide material in the concentrated form with water in an applicator with the specific applicator tank size.

In select embodiments of the pre-measured single use concentrated pesticide product, the specific applicator tank size may be, but is clearly not limited thereto: a ½-gallon tank for a handheld sprayer, a 1-gallon tank for the handheld sprayer; a 2-gallon tank for the handheld sprayer (or other various sizes of handheld sprayers); a 5-gallon tank (or the less common 4 gallon tank, or the like) for a backpack sprayer; and/or a 30-gallon tank (or other various sizes) for a broadcast sprayer. Wherein, the bottle may be sized and configured to hold the quantity of the pesticide material that is pre-measured for the ½-gallon tank for the handheld sprayer, the 1-gallon tank for the handheld sprayer, the 2-gallon tank for the handheld sprayer, the 5-gallon tank (or 4-gallon tank) for a backpack sprayer, the 30-gallon tank for the broadcast sprayer, or the like.

In select possibly preferred embodiments of the disclosed pre-measured single use concentrated pesticide product, the pesticide material may be a glufosinate-ammonium product. Wherein, in these possibly preferred embodiments, the pesticide material may be a herbicide material configured for single use weed killing. In select embodiments of the disclosed pre-measured single use concentrated pesticide product with the glufosinate-ammonium product, the bottle may include a 0.8-ounce bottle configured to hold the quantity of 0.8 ounces of the pesticide material in the concentrated form that is pre-measured for the ½-gallon tank of the handheld sprayer. In select embodiments of the disclosed pre-measured single use concentrated pesticide product with the glufosinate-ammonium product, the bottle may include a 1.6-ounce bottle configured to hold the quantity of 1.6 ounces of the pesticide material in the concentrated form that is pre-measured for the 1-gallon tank of the handheld sprayer. In select embodiments of the disclosed pre-measured single use concentrated pesticide product with the glufosinate-ammonium product, the bottle may include a 3.2-ounce bottle configured to hold the quantity of 3.2 ounces of the pesticide material in the concentrated form that is pre-measured for the 2-gallon tank of the handheld sprayer. In select embodiments of the disclosed pre-measured single use concentrated pesticide product with the glufosinate-ammonium product, the bottle may include an 8-ounce bottle configured to hold the quantity of 8.0 ounces of the pesticide material in the concentrated form that is pre-measured for the 5-gallon tank of the backpack sprayer, or the 4-gallon tank of the backpack sprayer. In select embodiments of the disclosed pre-measured single use concentrated pesticide product with the glufosinate-ammonium product, the bottle may include a 48-ounce or 60-ounce bottle configured to hold the quantity of 48.0-60.0 ounces of the pesticide material in the concentrated form that is pre-measured for the 30-gallon tank of the broadcast sprayer.

In select embodiments of the disclosed pre-measured single use concentrated pesticide product, including, but clearly not limited to embodiments with the glufosinate-ammonium product, the pesticide material may include a concentrated surfactant product. The concentrated surfactant product may be configured to reduce a surface tension of water mixed with the pesticide material, like the glufosinate-ammonium herbicide product.

In select embodiments of the disclosed pre-measured single use concentrated pesticide product, including, but clearly not limited to embodiments with the glufosinate-ammonium product, the pesticide material may include a concentrated residual pre-emergent product. The concentrated residual pre-emergent product may be designed and configured to keep weeds away for up to 8 months.

In select other embodiments of the disclosed pre-measured single use concentrated pesticide product, the pesticide material may include a glyphosate liquid material, a diquat liquid material, and a surfactant product. Wherein, the pesticide material may be a herbicide material configured for single use weed killing. In select embodiments of the disclosed pre-measured single use concentrated pesticide product with the glyphosate liquid material and diquat liquid material, the bottle may include a 1.6-ounce bottle configured to hold the quantity of 1.6 ounces of the pesticide material in the concentrated form that is pre-measured for the ½-gallon tank of the handheld sprayer. In select embodiments of the disclosed pre-measured single use concentrated pesticide product with the glyphosate liquid material and diquat liquid material, the bottle may include a 3.2-ounce bottle configured to hold the quantity of 3.2 ounces of the pesticide material in the concentrated form that is pre-measured for the 1-gallon tank of the handheld sprayer. In select embodiments of the disclosed pre-measured single use concentrated pesticide product with the glyphosate liquid material and diquat liquid material, the bottle may include a 6.4-ounce bottle configured to hold the quantity of 6.4 ounces of the pesticide material in the concentrated form that is pre-measured for the 2-gallon tank of the handheld sprayer. In select embodiments of the disclosed pre-measured single use concentrated pesticide product with the glyphosate liquid material and diquat liquid material, the bottle may include a 16-ounce bottle configured to hold the quantity of 16.0 ounces of the pesticide material in the concentrated form that is pre-measured for the 5-gallon tank of the backpack sprayer, or the 4-gallon tank of the backpack sprayer. In select embodiments of the disclosed pre-measured single use concentrated pesticide product with the glyphosate liquid material and diquat liquid material, the bottle may include a 96-ounce bottle configured to hold the quantity of 96.0 ounces of the pesticide material in the concentrated form that is pre-measured for the 30-gallon tank of the broadcast sprayer. In select embodiments of the pre-measured single use concentrated pesticide product, the pesticide material include: the glyphosate liquid material of or about 45% by volume of the concentrated form of the pesticide material; the diquat liquid material of or about 45% by volume of the concentrated form of the pesticide material; and the surfactant product of or about 10% by volume of the concentrated form of the pesticide material.

In select embodiments of the disclosed pre-measured single use concentrated pesticide product, the pesticide material may be any pesticide material or the like, including, but clearly not limited to, any herbicide products, any fungicide products, any fertilizer products, the like, and or any combinations thereof. In select possibly preferred embodiments of the disclosed pre-measured single use concentrated pesticide product, the pesticide material may be a herbicide product. The herbicide product may be a selective herbicide product or a non-selective herbicide product.

Another feature of the disclosed pre-measured single use concentrated pesticide product may be that it can be designed and configured to solve problems of time consumption and inefficiency in the field measuring out the correct quantities of pesticides for an applicator, including, but not limited to, a handheld sprayer, a backpack sprayer, a broadcast sprayer, or the like.

Another feature of the disclosed pre-measured single use concentrated pesticide product may be that it can be designed and configured to solve contamination concerns of a local work environment by removing any need to measure out liquids.

Another feature of the disclosed pre-measured single use concentrated pesticide product may be that it can be designed and configured to be commercially effective to transport to a local water source away from a vehicle, as typically water is needed to be added first before pesticides to prevent excessive foaming.

In another aspect, the instant disclosure embraces the disclosed pre-measured single used concentrated pesticide product in any of the various embodiments and/or combinations of embodiments shown and/or described herein.

In another aspect, the instant disclosure embraces a method of creating a pesticide spray. The disclosed method of creating a pesticide spray may include utilizing the disclosed pre-measured single use concentrated pesticide product in any of the various embodiments and/or combinations of embodiments shown and/or described herein. In general, the disclosed method of creating a pesticide spray may include providing the pre-measured single use concentrated pesticide product in any of the various embodiments and/or combinations of embodiments shown and/or described herein. As such, the provided pre-measured single use concentrated pesticide product may generally include a pesticide material in a concentrated form. The pesticide material may be in a quantity that is pre-measured for a specific applicator tank size. A bottle may be provided that is sized and configured to hold the quantity of the pesticide material that is pre-measured for the specific applicator tank size. With the provided pre-measured single use concentrated pesticide product, the method may further include scaling and packaging the pre-measured single use concentrated pesticide product in the bottle; opening the bottle with the pre-measured single use concentrated pesticide product; and mixing the provided pre-measured single use concentrated pesticide product with water in a tank of an applicator with the specific applicator tank size.

In select embodiments of the disclosed method of creating a pesticide spray, the pesticide material may be, but is not limited to, a herbicide product, a fungicide product, a fertilizer product, the like, and/or any various combinations thereof. In select embodiments of the disclosed method of creating a pesticide spray, the pesticide product may be herbicide product that may be a selective herbicide product or a non-selective herbicide product. In select possibly preferred embodiments of the disclosed method of creating a pesticide spray, the pesticide product may be a herbicide material configured for single use weed killing.

In select embodiments of the disclosed method of creating a pesticide spray, the specific applicator tank size may be, but is clearly not limited to: a ½-gallon tank for a handheld sprayer; a 1-gallon tank for the handheld sprayer; a 2-gallon tank for the handheld sprayer; a 5-gallon tank for a backpack sprayer (or a 4-gallon tank for a backpack sprayer); or a 30-gallon tank for a broadcast sprayer. Wherein, the bottle may be sized and configured to hold the quantity of the pesticide material that is pre-measured for the ½-gallon tank for the handheld sprayer, the 1-gallon tank for the handheld sprayer, the 2-gallon tank for the handheld sprayer, the 5-gallon tank for a backpack sprayer (or a 4-gallon tank for a backpack sprayer), or the 30-gallon tank for the broadcast sprayer. Wherein the bottle may include: a 0.8-ounce bottle configured to hold the quantity of 0.8 ounces of the pesticide material in the concentrated form that is pre-measured for the ½-gallon tank of the handheld sprayer; a 1.6-ounce bottle configured to hold the quantity of 1.6 ounces of the pesticide material in the concentrated form that is pre-measured for the 1-gallon tank of the handheld sprayer; a 3.2-ounce bottle configured to hold the quantity of 3.2 ounces of the pesticide material in the concentrated form that is pre-measured for the 2-gallon tank of the handheld sprayer; an 8-ounce bottle configured to hold the quantity of 8.0 ounces of the pesticide material in the concentrated form that is pre-measured for the 5-gallon tank of the backpack sprayer (or a 4-gallon tank for a backpack sprayer); or a 48-ounce or 60-ounce bottle configured to hold the quantity of 48.0-60.0 ounces of the pesticide material in the concentrated form that is pre-measured for the 30-gallon tank of the broadcast sprayer. Wherein, the mixing the provided pre-measured single use concentrated pesticide product with the water in the tank of the applicator with the specific applicator tank size may include: mixing the 0.8 ounces of the pesticide material in the concentrated form from the 0.8-ounce bottle with the water in the ½-gallon tank of the handheld sprayer; mixing the 1.6 ounces of the pesticide material in the concentrated form from the 1.6-ounce bottle with the water in the 1-gallon tank of the handheld sprayer; mixing the 3.2 ounces of the pesticide material in the concentrated form from the 3.2-ounce bottle with the water in the 2-gallon tank of the handheld sprayer; mixing the 8.0 ounces of the pesticide material in the concentrated form from the 8-ounce bottle with the water in the 5-gallon tank of the backpack sprayer (or a 4-gallon tank for a backpack sprayer); or mixing the 48.0-60.0 ounces of the pesticide material in the concentrated form from the 48-ounce or 60-ounce bottle with the water in the 30-gallon tank of the broadcast sprayer.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a front view of an example bottle or container with the disclosed pre-measured single use concentrated pesticide product according to select embodiments of the instant disclosure;

FIG. 2A is a front view of an example bottle or container with the disclosed pre-measured single use concentrated pesticide product according to select embodiments of the instant disclosure pre-measured for a ½-gallon handheld sprayer;

FIG. 2B is a front view of an example bottle or container with the disclosed pre-measured single use concentrated pesticide product according to select embodiments of the instant disclosure pre-measured for a 1-gallon handheld sprayer;

FIG. 2C is a front view of an example bottle or container with the disclosed pre-measured single use concentrated pesticide product according to select embodiments of the instant disclosure pre-measured for a 2-gallon handheld sprayer;

FIG. 2D is a front view of an example bottle or container with the disclosed pre-measured single use concentrated pesticide product according to select embodiments of the instant disclosure pre-measured for a 5-gallon backpack sprayer (or a 4-gallon backpack sprayer);

FIG. 2E is a front view of an example bottle or container with the disclosed pre-measured single use concentrated pesticide product according to select embodiments of the instant disclosure pre-measured for a 30-gallon broadcast sprayer;

FIG. 3A is a diagram an example bottle or container with the disclosed pre-measured single use concentrated pesticide product and an example ½-gallon hand sprayer that the shown example bottle or container of pesticide product is pre-measured for;

FIG. 3B is a diagram an example bottle or container with the disclosed pre-measured single use concentrated pesticide product and an example 1-gallon hand sprayer that the shown example bottle or container of pesticide product is pre-measured for;

FIG. 3C is a diagram an example bottle or container with the disclosed pre-measured single use concentrated pesticide product and an example 2-gallon hand sprayer that the shown example bottle or container of pesticide product is pre-measured for;

FIG. 3D is a diagram an example bottle or container with the disclosed pre-measured single use concentrated pesticide product and an example 5-gallon backpack sprayer (or a 4-gallon backpack sprayer) that the shown example bottle or container of pesticide product is pre-measured for;

FIG. 3E is a diagram an example bottle or container with the disclosed pre-measured single use concentrated pesticide product and an example 30-gallon broadcast sprayer that the shown example bottle or container of pesticide product is pre-measured for;

FIG. 4 is a diagram of the disclosed pre-measured single use concentrated pesticide product in use with a hand sprayer;

FIG. 5 is a diagram of the disclosed pre-measured single use concentrated pesticide product in use with a backpack sprayer;

FIG. 6 is a diagram of the disclosed pre-measured single use concentrated pesticide product in use with a broadcast sprayer typically mounted on the back of an ATV or tractor;

FIG. 7 is a diagram of the disclosed pre-measured single use concentrated pesticide product in use with a broadcast sprayer towed behind an ATV or tractor; and

FIG. 8 is a flow diagram of the method of spraying a pesticide product according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

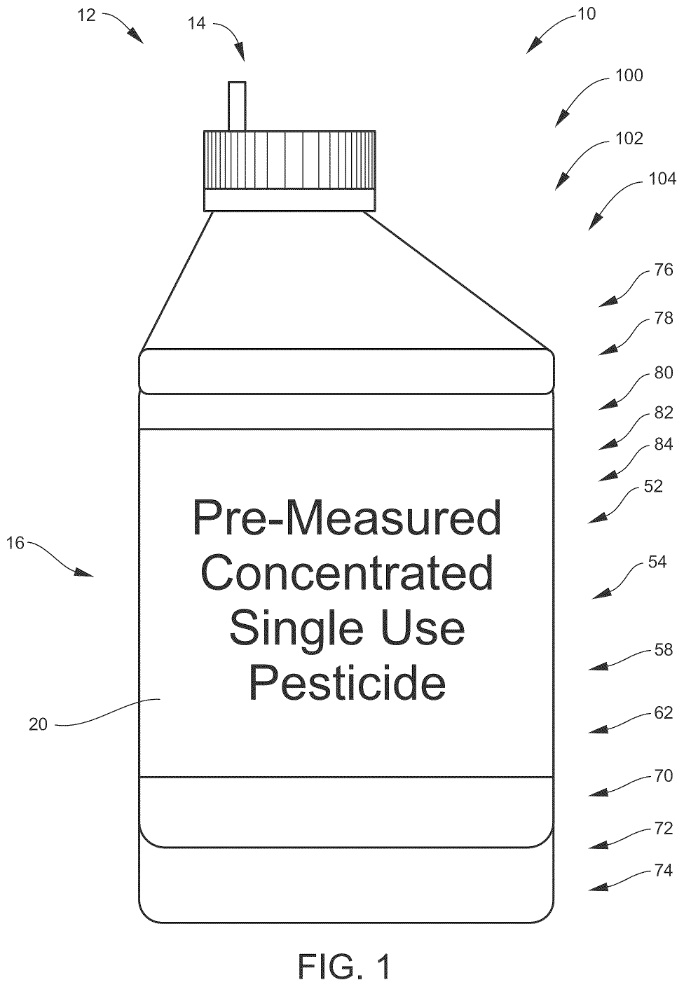

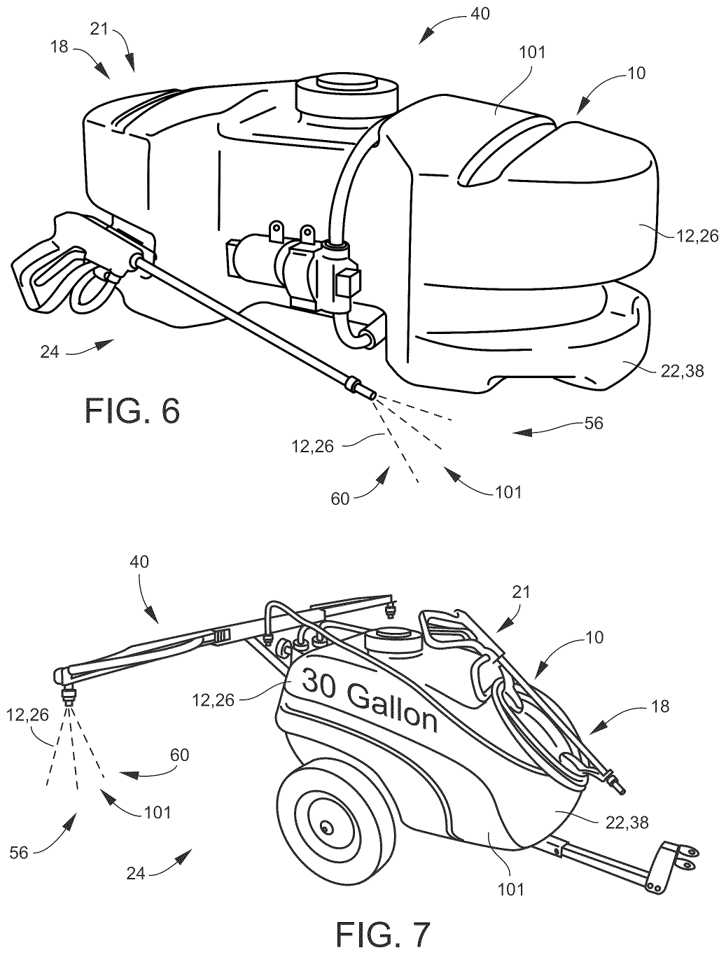

Referring now to FIGS. 1-8, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-7, the present disclosure may solve the aforementioned limitations of the currently available pesticides by providing the disclosed pre-measured single use concentrated pesticide product 10. Pre-measured single use concentrated pesticide product 10 may generally include pesticide material 12 in concentrated form 14. Pesticide material 12 may be in quantity 16 that is pre-measured for specific applicator tank size 18. Bottle 20 or any small container, vessel, or the like, may be provided that is sized and configured to hold quantity 16 of pesticide material 12 that is pre-measured for the specific applicator tank size 18. The pesticide material may be sealed and packaged inside of the bottle.

One feature of pre-measured single use concentrated pesticide product 10 may be that it can be designed and configured to optimize efficiency in mixing pesticide material 12 in concentrated form 14 with water 26 in applicator 21 with specific applicator tank size 18. Single use, as used herein, may refer to product 10 being intended to be completely used or emptied into tank 22 of applicator 21. The concentrated form 14 of pesticide material 12 in pre-measured single use concentrated pesticide product 10 may allow the quantity 16 to be as small as possible, so the more concentrated the pesticide material 12 is the smaller quantity 16 may be. The smaller quantity 16 may be the smaller bottle 20 may be used, thereby making, storage, transportation, or the like easier and more efficient for pre-measured single use concentrated pesticide product 10. In addition, applicator 21 may be any size or type of applicator, including but not limited to, handheld sprayer 30, backpack sprayer 36 (4-gallon or 5-gallon tank), broadcast sprayer 40 (30-gallon tank or similar thereto), the like, etc. As such, pre-measured single use concentrated pesticide product 10 may be sized and configured for various sizes of specific applicator tank size 18 of various applicators 21.

Another feature of pre-measured single use concentrated pesticide product 10 may be that it can be designed and configured to create safer work environment 24 when mixing pesticide material 12 in concentrated form 14 with water 26 in applicator 21 with specific applicator tank size 18.

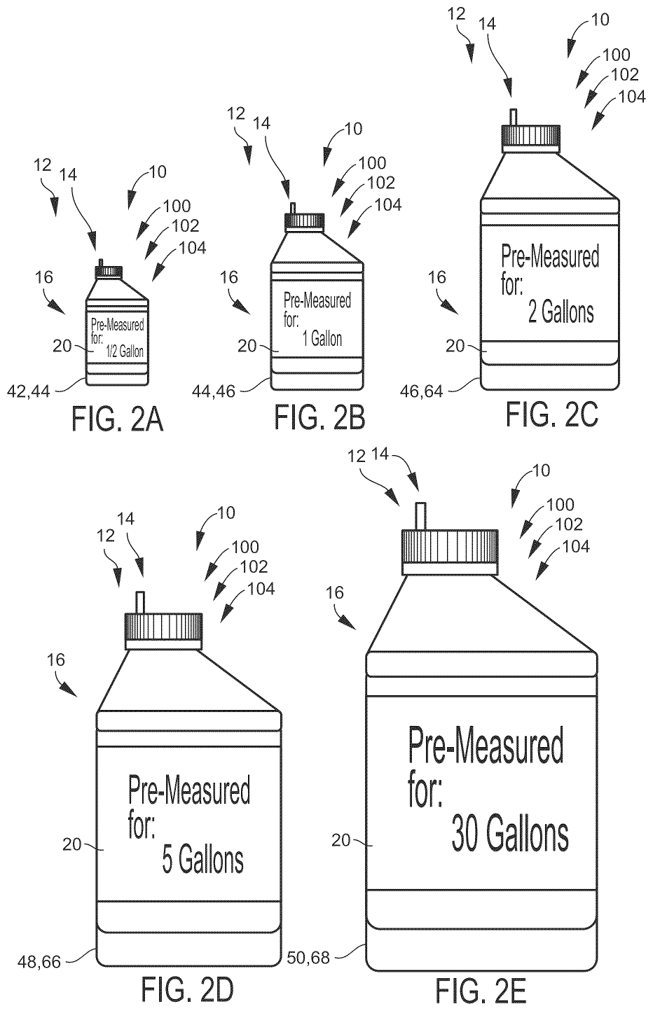

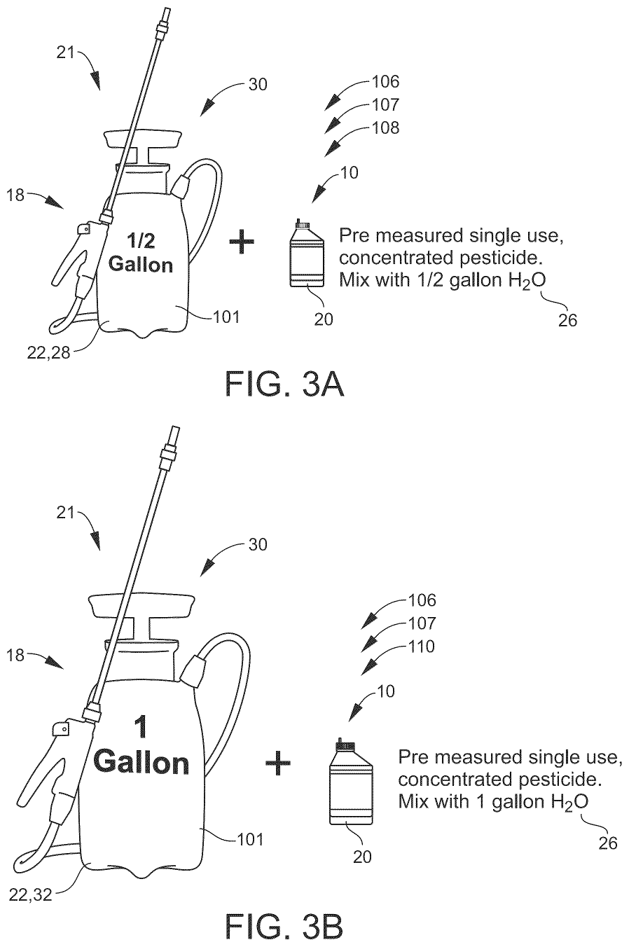

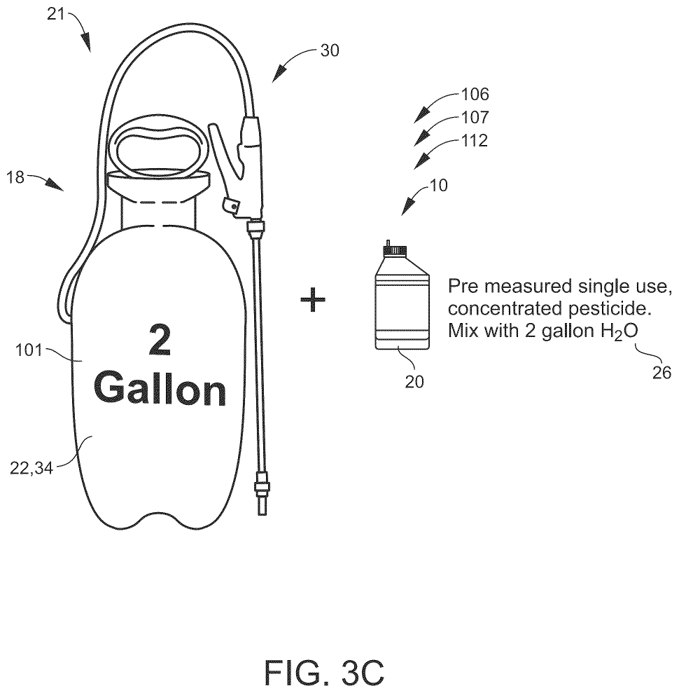

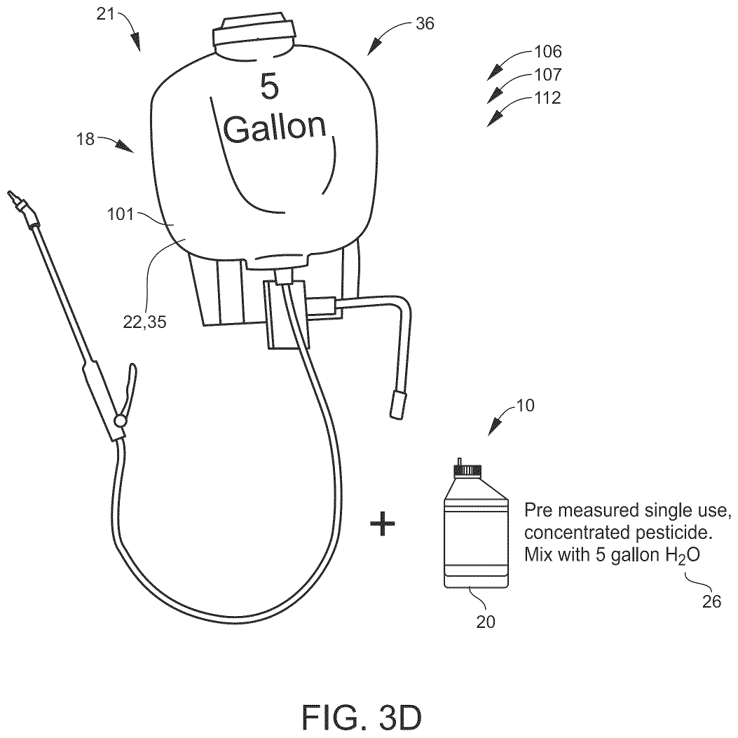

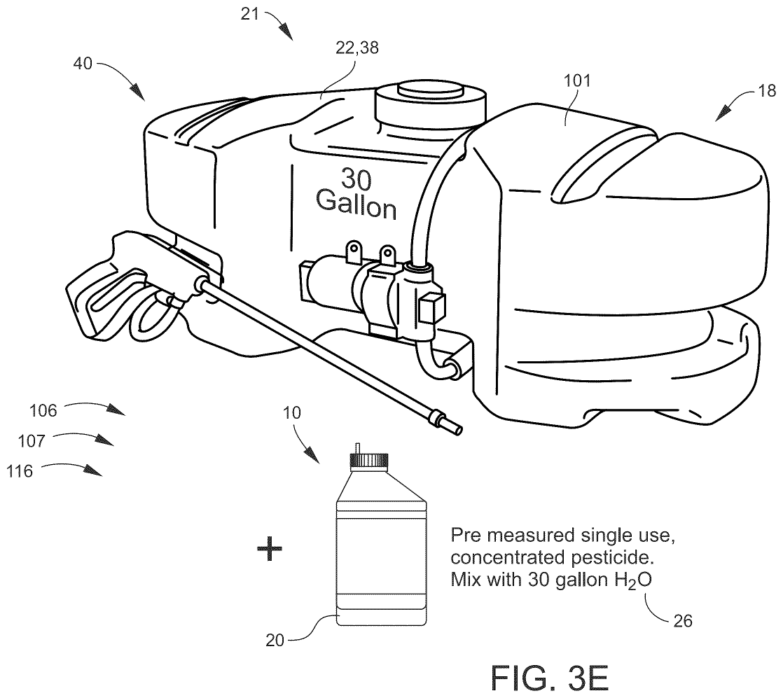

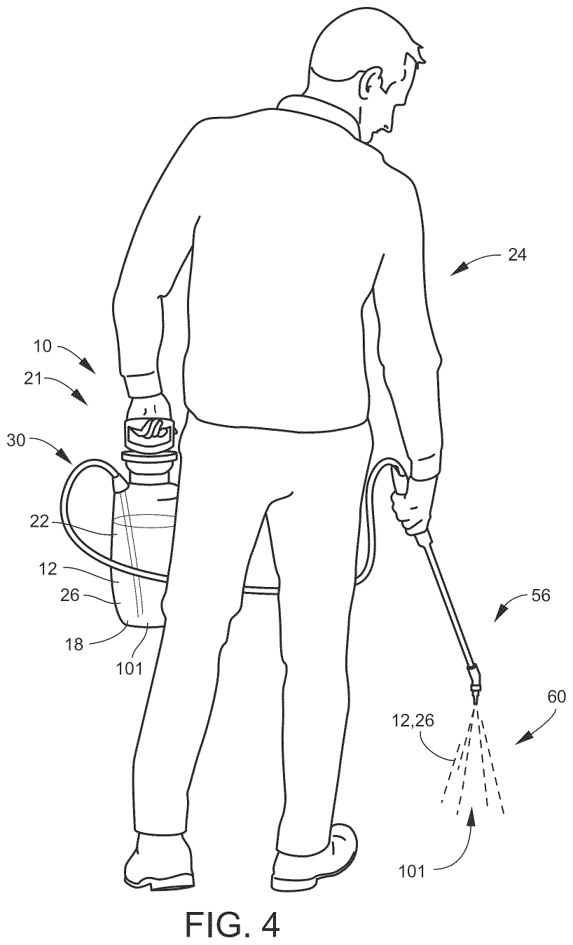

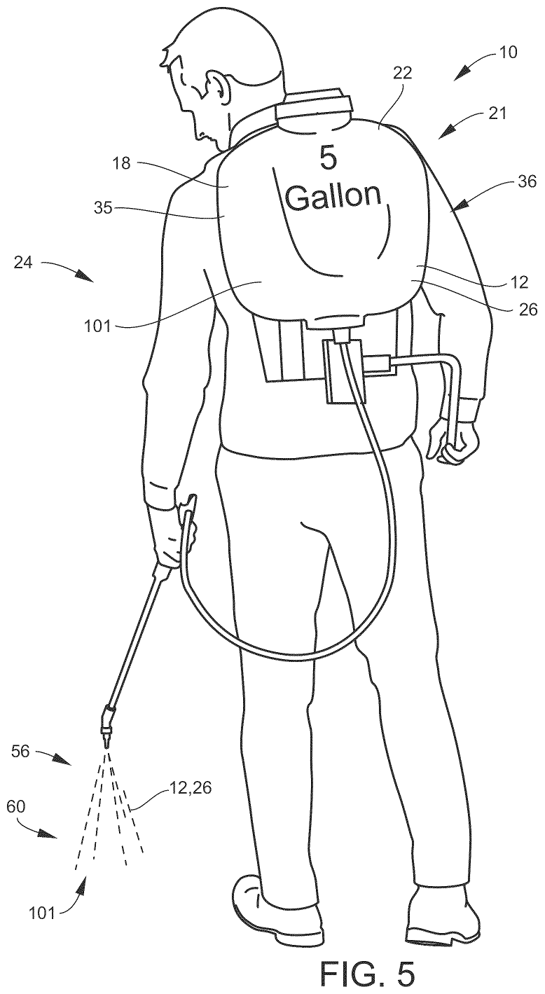

Referring specifically to FIGS. 2-7, in select embodiments of pre-measured single use concentrated pesticide product 10, specific applicator tank size 18 may be, but is clearly not limited thereto: ½-gallon tank 28 for handheld sprayer 30 (see FIGS. 3A and 4), 1-gallon tank 32 for handheld sprayer 30 (see FIGS. 3B and 4); 2-gallon tank 34 for the handheld sprayer (see FIGS. 3C and 4), or other various sizes of handheld sprayer 30; 5-gallon tank 35 (or the less common 4 gallon tank, or the like) for backpack sprayer 36 (see FIGS. 3D and 5); and/or 30-gallon tank 38 (or other various sizes) for broadcast sprayer 40 (see FIGS. 3E, 6 and 7). Wherein, bottle 20 may be sized and configured to hold quantity 16 of pesticide material 12 that is pre-measured for ½-gallon tank 28 for handheld sprayer 30, 1-gallon tank 32 for handheld sprayer 30, 2-gallon tank 34 for handheld sprayer 30, 5-gallon tank (or 4-gallon tank) 35 for backpack sprayer 36, 30-gallon tank 38 for broadcast sprayer 40, the like, or any other various sizes of tanks 22 for applicator 21.

Pre-measured single use concentrated pesticide product 10 may include any pesticide material 12 pre-measured for specific applicator tank size 18, including, but not limited to, any herbicide products or materials 54, any fungicide products 76, any fertilizer products 78, the like, and/or any combinations thereof. In select possibly preferred embodiments of pre-measured single use concentrated pesticide product 10, pesticide material 12 may include glufosinate-ammonium product 52. Wherein, in these possibly preferred embodiments, pesticide material 12 may be herbicide material 54 configured for single use weed killing 56 (see FIGS. 4-7). In select embodiments of pre-measured single use concentrated pesticide product 10 with the glufosinate-ammonium product 52, bottle 20 may include 0.8-ounce bottle 42 (see FIGS. 2A and 3A) configured to hold quantity 16 of 0.8 ounces (or approximately thereof) of pesticide material 12 in concentrated form 14 that may be pre-measured for ½-gallon tank 28 of handheld sprayer 30 (see FIG. 3A). In select embodiments of pre-measured single use concentrated pesticide product 10 with glufosinate-ammonium product 52, bottle 20 may include a 1.6-ounce bottle 44 (see FIGS. 2B and 3B) configured to hold quantity 16 of 1.6 ounces (or approximately thereof) of pesticide material 12 in concentrated form 14 that may be pre-measured for 1-gallon tank 32 of handheld sprayer 30 (see FIG. 3B). In select embodiments of pre-measured single use concentrated pesticide product 10 with glufosinate-ammonium product 52, bottle 20 may include 3.2-ounce bottle 46 (see FIGS. 2C and 3C) configured to hold quantity 16 of 3.2 ounces (or approximately thereof) of pesticide material 12 in concentrated form 14 that is pre-measured for 2-gallon tank 34 of handheld sprayer 30 (see FIG. 3C). In select embodiments of pre-measured single use concentrated pesticide product 10 with glufosinate-ammonium product 52, bottle 20 may include 8-ounce bottle 48 (see FIGS. 2D and 3D) configured to hold quantity 16 of 8.0 ounces of pesticide material 12 in concentrated form 14 that is pre-measured for 5-gallon tank (or 4-gallon tank) 35 of backpack sprayer 36 (see FIG. 3D). In select embodiments of pre-measured single use concentrated pesticide product 10 with glufosinate-ammonium product 52, bottle 20 may include 48-ounce or 60-ounce bottle 50 (see FIGS. 2E and 3E) configured to hold quantity 16 of 48.0-60.0 ounces of pesticide material 12 in concentrated form 14 that is pre-measured for 30-gallon tank of broadcast sprayer 40 (see FIG. 3E). However, the disclosure is clearly not limited to these exact quantities 16 and sizes of bottles 20, nor to the specific applicator tank size 18, and pre-measured single use concentrated pesticide product 10 may be designed and configured for any quantities 16, any sizes of bottles 20, and/or any specific applicator tank size 18.

In select embodiments of pre-measured single use concentrated pesticide product 10, pesticide material 12 may further include concentrated surfactant 58. Concentrated surfactant 58 may be included with any embodiments of pre-measured single use concentrated pesticide product 10. Concentrated surfactant product 58 may be configured to reduce surface tension 60 of water 26 mixed with pesticide material 12, including, but not limited to, glufosinate-ammonium herbicide product 52. As such, in select possibly preferred embodiments, pre-measured single use concentrated pesticide product 10 may include glufosinate-ammonium product 52 and concentrated surfactant 58.

In select embodiments of pre-measured single use concentrated pesticide product 10, pesticide material 12 may further include concentrated residual pre-emergent product 62. Concentrated residual pre-emergent product 62 may be designed and configured to keep weeds away, like for up to 8 months. As such, in select possibly preferred embodiments, pre-measured single use concentrated pesticide product 10 may include glufosinate-ammonium product 52 and concentrated residual pre-emergent product 62. In other select possibly preferred embodiments, pre-measured single use concentrated pesticide product 10 may include glufosinate-ammonium product 52, concentrated surfactant 58, and concentrated residual pre-emergent product 62.

In select other embodiments of pre-measured single use concentrated pesticide product 10, pesticide material 12 may include glyphosate liquid material 70, diquat liquid material 72, and surfactant product 74. Wherein, pesticide material 12 of pre-measured single use concentrated pesticide product 10 may be herbicide material 54 configured for single use weed killing 56 (see FIGS. 4-7). In select embodiments of pre-measured single use concentrated pesticide product 10 with glyphosate liquid material 70 and diquat liquid material 72, bottle 2—may include 1.6-ounce bottle 44 (see FIGS. 2A and 3A) configured to hold quantity 16 of 1.6 ounces of pesticide material 12 in concentrated form 14 that is pre-measured for ½-gallon tank 28 of handheld sprayer 30 (see FIG. 3A). In select embodiments of pre-measured single use concentrated pesticide product 10 with glyphosate liquid material 70 and diquat liquid material 72, bottle 20 may include 3.2-ounce bottle 46 (see FIGS. 2B and 3B) configured to hold quantity 16 of 3.2 ounces of pesticide material 12 in concentrated form 14 that is pre-measured for 1-gallon tank 32 of handheld sprayer 30 (see FIG. 3B). In select embodiments of pre-measured single use concentrated pesticide product 10 with glyphosate liquid material 70 and diquat liquid material 72, bottle 20 may include 6.4-ounce bottle 64 (see FIGS. 2C and 3C) configured to hold quantity 16 of 6.4 ounces of pesticide material 12 in concentrated form 14 that is pre-measured for 2-gallon tank 34 of handheld sprayer 30 (see FIG. 3C). In select embodiments of pre-measured single use concentrated pesticide product 10 with the glyphosate liquid material 70 and diquat liquid material 72, bottle 20 may include 16-ounce bottle 66 (see FIGS. 2D and 3D) configured to hold quantity 16 of 16.0 ounces of pesticide material 12 in concentrated form 14 that is pre-measured for 5-gallon tank (or 4-gallon tank) 35 of backpack sprayer 36 (see FIG. 3D). In select embodiments of pre-measured single use concentrated pesticide product 10 with glyphosate liquid material 70 and diquat liquid material 72, bottle 20 may include 96-ounce bottle 68 (see FIGS. 2E and 3E) configured to hold quantity 16 of 96.0 ounces of the pesticide material 12 in concentrated form 14 that is pre-measured for 30-gallon tank 38 of broadcast sprayer 40 (see FIG. 3E). In select embodiments of pre-measured single use concentrated pesticide product 10, pesticide material 12 may include: glyphosate liquid material 70 of or about 45% by volume of concentrated form 14 of pesticide material 12; diquat liquid material 72 of or about 45% by volume of concentrated form 14 of pesticide material 12; and surfactant product 74 of or about 10% by volume of concentrated form 14 of pesticide material 12.

In select embodiments of pre-measured single use concentrated pesticide product 10, pesticide material 12 may be any pesticide material or the like, including, but clearly not limited to, any herbicide products or materials 54 or the like, any fungicide products 76 or the like, any fertilizer products 78 or the like, the like, and or any combinations 80 thereof. In select possibly preferred embodiments of pre-measured single use concentrated pesticide product 10, pesticide material 12 may be herbicide product or material 54. Herbicide product or material 54 may be any selective herbicide product 82 or any non-selective herbicide product 84.

Another feature of pre-measured single use concentrated pesticide product 10 may be that it can be designed and configured to solve problems of time consumption and inefficiency in the field measuring out the correct quantities of pesticides for applicator 21, like handheld sprayer 30, backpack sprayer 36, broadcast sprayer 40, and/or the like.

Another feature of pre-measured single use concentrated pesticide product 10 may be that it can be designed and configured to solve contamination concerns of a local work environment 24 by removing any need to measure out liquids.

Another feature of pre-measured single use concentrated pesticide product 10 may be that it can be designed and configured to be commercially effective to transport to a local water source away from a vehicle, as typically water is needed to be added first before pesticides to prevent excessive foaming.

In another aspect, the instant disclosure embraces pre-measured single used concentrated pesticide product 10 in any of the various embodiments and/or combinations of embodiments shown and/or described herein.

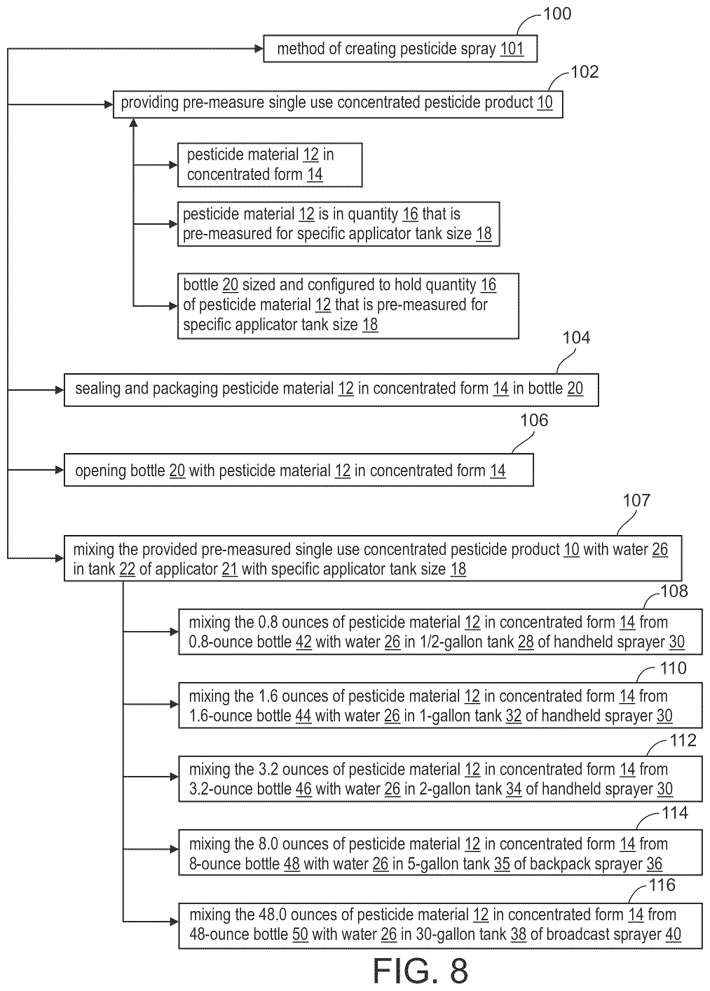

Referring now specifically to FIG. 8, in another aspect, the instant disclosure embraces method 100 of creating pesticide spray 101 (see FIGS. 3-7). Method 100 of creating pesticide spray 101 may include utilizing pre-measured single use concentrated pesticide product 10 in any of the various embodiments and/or combinations of embodiments shown and/or described herein. In general, method 100 of creating pesticide spray 101 may include step 102 of providing pre-measured single use concentrated pesticide product 10 in any of the various embodiments and/or combinations of embodiments shown and/or described herein. As such, the provided pre-measured single use concentrated pesticide product 10 may generally include pesticide material 12 in concentrated form 14. Pesticide material 12 may be in quantity 16 that is pre-measured for specific applicator tank size 18. Bottle 20 may be provided that is sized and configured to hold quantity 16 of pesticide material 12 that is pre-measured for specific applicator tank size 18. With the provided pre-measured single use concentrated pesticide product 10, method 100 may further include step 104 of scaling and packaging pre-measured single use concentrated pesticide product 10 in bottle 20. Step 104 of sealing and packaging pre-measured single use concentrated pesticide product 10 in bottle 20 may include any necessary steps to commercially sell bottles 20 of pre-measured single use concentrated pesticide product 10, including, but not limited to, passing any regulations, providing any production or manufacturing of pesticide material 12 in concentrated form 14, any shipping, any marketing, any distribution, any retailing, the like, etc. of pre-measured single use concentrated pesticide product 10 in bottle 20. With pre-measured single use concentrated pesticide product 10 sealed and packaged in bottle 20, method 100 of creating pesticide spray 101 may further include step 106 of opening bottle 20 with pre-measured single use concentrated pesticide product 10. Once bottle 20 is opened, method 100 of creating pesticide spray 101 may further include step 107 of mixing the provided pre-measured single use concentrated pesticide product 10 with water 26, like in tank 22 of applicator 21 with specific applicator tank size 18.

In select embodiments of method 100 of creating pesticide spray 101, pesticide material 12 may be, but is not limited to, herbicide product or material 54, fungicide product 76, fertilizer product 78, the like, and/or any various combinations thereof. In select embodiments of method 100 of creating pesticide spray 101, pesticide material 12 may be herbicide product or material 54 that may be selective herbicide product 82 or non-selective herbicide product 84. In select possibly preferred embodiments of method 100 of creating pesticide spray 101, pesticide material 12 may be herbicide material 54 configured for single use weed killing 56.

In select embodiments of method 100 of creating pesticide spray 101, the specific applicator tank size 18 may be, but is clearly not limited to: ½-gallon tank 28 for handheld sprayer 30; 1-gallon tank 32 for handheld sprayer 30; 2-gallon tank 34 for handheld sprayer 30; 5-gallon tank (or 4-gallon tank) 35 for backpack sprayer 36; or 30-gallon tank 38 for broadcast sprayer 40. Wherein, bottle 20 may be sized and configured to hold quantity 16 of pesticide material 12 that is pre-measured for ½-gallon tank 28 for handheld sprayer 30, 1-gallon tank 32 for handheld sprayer 30, 2-gallon tank 34 for handheld sprayer 30, 5-gallon tank (or 4-gallon tank) 35 for backpack sprayer 36, or 30-gallon tank 38 for broadcast sprayer 40. Wherein bottle 20 may include: 0.8-ounce bottle 42 configured to hold quantity 16 of 0.8 ounces of pesticide material 12 in concentrated form 14 that is pre-measured for ½-gallon tank 28 of handheld sprayer 30; 1.6-ounce bottle 44 configured to hold quantity 16 of 1.6 ounces of pesticide material 12 in concentrated form 14 that is pre-measured for 1-gallon tank 32 of handheld sprayer 34; 3.2-ounce bottle 46 configured to hold quantity 16 of 3.2 ounces of pesticide material 12 in concentrated form 14 that is pre-measured for 2-gallon tank 34 of handheld sprayer 30; 8-ounce bottle 48 configured to hold quantity 16 of 8.0 ounces of pesticide material 12 in concentrated form 14 that is pre-measured for 5-gallon tank (or 4-gallon tank) 35 of backpack sprayer 36; or 48-ounce or 60-ounce bottle 50 configured to hold quantity 16 of 48.0-60.0 ounces of pesticide material 12 in concentrated form 14 that is pre-measured for 30-gallon tank 38 of broadcast sprayer 40. Wherein, step 107 of mixing the provided pre-measured single use concentrated pesticide product 10 with water 26 in tank 22 of applicator 21 with specific applicator tank size 18 may include: step 108 of mixing the 0.8 ounces of pesticide material 12 in concentrated form 14 from 0.8-ounce bottle 42 with water 26 in ½-gallon tank 28 of handheld sprayer 30; step 110 of mixing the 1.6 ounces of pesticide material 12 in concentrated form 14 from 1.6-ounce bottle 44 with water 26 in 1-gallon tank 32 of handheld sprayer 30; step 112 of mixing the 3.2 ounces of pesticide material 12 in concentrated form 14 from 3.2-ounce bottle 46 with water 26 in 2-gallon tank 34 of handheld sprayer 30; step 114 of mixing 8.0 ounces of pesticide material 12 in concentrated form 14 from 8-ounce bottle 48 with water 26 in 5-gallon tank (or 4-gallon tank) 35 of backpack sprayer 36; or step 116 of mixing the 48.0-60.0 ounces of pesticide material 12 in concentrated form 14 from 48-ounce or 60-ounce bottle 50 with water 26 in 30-gallon tank 38 of broadcast sprayer 40.

In sum, the disclosed pre-measured, single use concentrated pesticide product 10 and method 200 of creating pesticide spray with such pre-measured, single use concentrated pesticide product 10 may be designed and configured to optimize efficiency and create safer work environment 24 by providing a product with a premeasured single use concentrated product, like a herbicide product or material 54 (selective 82 or non-selective herbicide 84), fungicide product 76, fertilizer product 78, or the like, packed in a small container or bottle 20, including, but not limited to, a small 16 oz. container or bottle 66 or a small 8 oz. container or bottle 48. The intention of the disclosed product 10 and method 100 of use thereof is to solve the problem(s) of time consumption and inefficiency in the field measuring out the correct quantities, including, but not limited to, for 4 or 5 gallon backpack sprayers 36. Additionally, the disclosed product 10 and method 100 of use thereof may also solve contamination concerns of a local work environment 24 by removing the need to measure out liquids. Commercially, this is extremely effective to transport to a local water source away from the vehicle, as an example, typically water 26 is needed to be added first before pesticides to prevent excessive “Foaming”.

As such, a feature of the disclosed product 10 and/or method 100 of use thereof may be its ability to prevent the need to measure out liquids in the field.

Another feature of the disclosed product 10 and/or method 100 of use thereof may be the ability to prevent contamination of local area for providing a safer work environment 24.

Another feature of the disclosed product 10 and/or method 100 of use thereof may be the ability to increase efficiency and save time.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A pre-measured single use concentrated pesticide product comprising:
a pesticide material in a concentrated form, the pesticide material is in a quantity that is pre-measured for a specific applicator tank size;
a bottle sized and configured to hold the quantity of the pesticide material that is pre-measured for the specific applicator tank size; and
the pesticide material is sealed and packaged inside of the bottle.

2. The pre-measured single use concentrated pesticide product according to claim 1 designed and configured to optimize efficiency in mixing the pesticide material in the concentrated form with water in an applicator with a tank having the specific applicator tank size.

3. The pre-measured single use concentrated pesticide product according to claim 1 designed and configured to create a safer work environment when mixing the pesticide material in the concentrated form with water in an applicator with a tank having the specific applicator tank size.

4. The pre-measured single use concentrated pesticide product according to claim 1, wherein the specific applicator tank size is:
a ½-gallon tank for a handheld sprayer;
a 1-gallon tank for the handheld sprayer;
a 2-gallon tank for the handheld sprayer;
a 4-gallon tank or 5-gallon tank for a backpack sprayer; or
a 30-gallon tank for a broadcast sprayer; and
wherein, the bottle is sized and configured to hold the quantity of the pesticide material that is pre-measured for the ½-gallon tank for the handheld sprayer, the 1-gallon tank for the handheld sprayer, the 2-gallon tank for the handheld sprayer, the 4-gallon or 5-gallon tank for the backpack sprayer, or the 30-gallon tank for the broadcast sprayer.

5. The pre-measured single use concentrated pesticide product according to claim 4, wherein the bottle including:
a 0.8-ounce bottle configured to hold the quantity of 0.8 ounces of the pesticide material in the concentrated form that is pre-measured for the ½-gallon tank of the handheld sprayer;
a 1.6-ounce bottle configured to hold the quantity of 1.6 ounces of the pesticide material in the concentrated form that is pre-measured for the 1-gallon tank of the handheld sprayer;
a 3.2-ounce bottle configured to hold the quantity of 3.2 ounces of the pesticide material in the concentrated form that is pre-measured for the 2-gallon tank of the handheld sprayer;
an 8-ounce bottle configured to hold the quantity of 8.0 ounces of the pesticide material in the concentrated form that is pre-measured for the 4-gallon or 5-gallon tank of the backpack sprayer; or
a 48-ounce or 60-ounce bottle configured to hold the quantity of 48.0-60.0 ounces of the pesticide material in the concentrated form that is pre-measured for the 30-gallon tank of the broadcast sprayer.

6. The pre-measured single use concentrated pesticide product according to claim 5, wherein the pesticide material including a glufosinate-ammonium product, wherein the pesticide material is a herbicide material configured for single use weed killing.

7. The pre-measured single use concentrated pesticide product according to claim 6, wherein the pesticide material further including a concentrated surfactant product configured to reduce a surface tension of water mixed with the glufosinate-ammonium herbicide product.

8. The pre-measured single use concentrated pesticide product according to claim 6, wherein the pesticide material further including a concentrated residual pre-emergent product designed and configured to keep weeds away for up to 8 months.

9. The pre-measured single use concentrated pesticide product according to claim 4, wherein the bottle including:
a 1.6-ounce bottle configured to hold the quantity of 1.6 ounces of the pesticide material in the concentrated form that is pre-measured for the ½-gallon tank of the handheld sprayer;
a 3.2-ounce bottle configured to hold the quantity of 3.2 ounces of the pesticide material in the concentrated form that is pre-measured for the 1-gallon tank of the handheld sprayer;
a 6.4-ounce bottle configured to hold the quantity of 6.4 ounces of the pesticide material in the concentrated form that is pre-measured for the 2-gallon tank of the handheld sprayer;
a 16-ounce bottle configured to hold the quantity of 16.0 ounces of the pesticide material in the concentrated form that is pre-measured for the 4-gallon or 5-gallon tank of the backpack sprayer; or
a 96-ounce bottle configured to hold the quantity of 96.0 ounces of the pesticide material in the concentrated form that is pre-measured for the 30-gallon tank of the broadcast sprayer.

10. The pre-measured single use concentrated pesticide product according to claim 9, wherein the pesticide material including a glyphosate liquid material, a diquat liquid material, and a surfactant product, wherein the pesticide material is a herbicide material configured for single use weed killing.

11. The pre-measured single use concentrated pesticide product according to claim 10, wherein the pesticide material including:
the glyphosate liquid material of or about 45% by volume of the concentrated form of the pesticide material;
the diquat liquid material of or about 45% by volume of the concentrated form of the pesticide material; and
the surfactant product of or about 10% by volume of the concentrated form of the pesticide material.

12. The pre-measured single use concentrated pesticide product according to claim 1, wherein the pesticide material is selected from the group consisting of: a herbicide product, a fungicide product; and a fertilizer product.

13. The pre-measured single use concentrated pesticide product according to claim 12, wherein the pesticide material is the herbicide product.

14. The pre-measured single use concentrated pesticide product according to claim 13, wherein the herbicide product is a selective herbicide product or a non-selective herbicide product.

15. The pre-measured single use concentrated pesticide product according to claim 1 being designed and configured to:
solve problems of time consumption and inefficiency in the field measuring out correct quantities of pesticides for an applicator, a handheld sprayer, a backpack sprayer, or a broadcast sprayer;
solve contamination concerns of a local work environment by removing any need to measure out liquids;
be commercially effective to transport to a local water source away from a vehicle, as typically water is needed to be added first before pesticides to prevent excessive foaming; or
combinations thereof.

16. A pre-measured single use concentrated pesticide product comprising:
a pesticide material in a concentrated form, the pesticide material is in a quantity that is pre-measured for a specific applicator tank size;
a bottle sized and configured to hold the quantity of the pesticide material that is pre-measured for the specific applicator tank size;
wherein the specific applicator tank size is:
a ½-gallon tank for a handheld sprayer;
a 1-gallon tank for the handheld sprayer;
a 2-gallon tank for the handheld sprayer;
a 4-gallon or 5-gallon tank for a backpack sprayer; or
a 30-gallon tank for a broadcast sprayer;
wherein, the bottle is sized and configured to hold the quantity of the pesticide material that is pre-measured for the ½-gallon tank for the handheld sprayer, the 1-gallon tank for the handheld sprayer, the 2-gallon tank for the handheld sprayer, the 4-gallon or 5-gallon tank for the backpack sprayer, or the 30-gallon tank for the broadcast sprayer;
wherein the bottle including:
a 0.8-ounce bottle configured to hold the quantity of 0.8 ounces of the pesticide material in the concentrated form that is pre-measured for the ½-gallon tank of the handheld sprayer;
a 1.6-ounce bottle configured to hold the quantity of 1.6 ounces of the pesticide material in the concentrated form that is pre-measured for the 1-gallon tank of the handheld sprayer;
a 3.2-ounce bottle configured to hold the quantity of 3.2 ounces of the pesticide material in the concentrated form that is pre-measured for the 2-gallon tank of the handheld sprayer;
an 8-ounce bottle configured to hold the quantity of 8.0 ounces of the pesticide material in the concentrated form that is pre-measured for the 4-gallon or 5-gallon tank of the backpack sprayer; or
a 48-ounce or 60-ounce bottle configured to hold the quantity of 48.0-60.0 ounces of the pesticide material in the concentrated form that is pre-measured for the 30-gallon tank of the broadcast sprayer;
wherein the pesticide material including a glufosinate-ammonium product, wherein the pesticide material is a herbicide material configured for single use weed killing;
the pesticide material is sealed and packaged inside of the bottle; and
wherein, the pre-measured single use concentrated pesticide product is designed and configured to:
optimize efficiency in mixing the pesticide material in the concentrated form with water in an applicator with the specific applicator tank size;
create a safer work environment when mixing the pesticide material in the concentrated form with the water in an applicator with the specific applicator tank size;
solve problems of time consumption and inefficiency in the field measuring out the correct quantities of pesticides for the applicator;
solve contamination concerns of a local work environment by removing any need to measure out liquids; and
be commercially effective to transport to a local water source away from a vehicle, as typically the water is needed to be added first before pesticides to prevent excessive foaming.

17. A method of creating a pesticide spray comprising:
providing a pre-measured single use concentrated pesticide product comprising:
a pesticide material in a concentrated form, the pesticide material is in a quantity that is pre-measured for a specific applicator tank size;
a bottle sized and configured to hold the quantity of the pesticide material that is pre-measured for the specific applicator tank size;
sealing and packaging the pre-measured single use concentrated pesticide product in the bottle;
opening the bottle with the pre-measured single use concentrated pesticide product; and
mixing the provided pre-measured single use concentrated pesticide product with water in a tank of an applicator with the specific applicator tank size.

18. The method of creating a pesticide spray according to claim 17, wherein the pesticide material is selected from a group consisting of: a herbicide product, a fungicide product; a fertilizer product; and a combination thereof; and
wherein the herbicide product is a selective herbicide product or a non-selective herbicide product.

19. The method of creating a pesticide spray according to claim 17, wherein the pesticide material including a glufosinate-ammonium product, wherein the pesticide material is a herbicide material configured for single use weed killing.

20. The method of creating a pesticide spray according to claim 19, wherein the specific applicator tank size is:
a ½-gallon tank for a handheld sprayer;
a 1-gallon tank for the handheld sprayer;
a 2-gallon tank for the handheld sprayer;
a 4-gallon or 5-gallon tank for a backpack sprayer; or
a 30-gallon tank for a broadcast sprayer;
wherein, the bottle is sized and configured to hold the quantity of the pesticide material that is pre-measured for the ½-gallon tank for the handheld sprayer, the 1-gallon tank for the handheld sprayer, the 2-gallon tank for the handheld sprayer, the 4-gallon or 5-gallon tank for the backpack sprayer, or the 30-gallon tank for the broadcast sprayer;
wherein the bottle including:
a 0.8-ounce bottle configured to hold the quantity of 0.8 ounces of the pesticide material in the concentrated form that is pre-measured for the ½-gallon tank of the handheld sprayer;
a 1.6-ounce bottle configured to hold the quantity of 1.6 ounces of the pesticide material in the concentrated form that is pre-measured for the 1-gallon tank of the handheld sprayer;
a 3.2-ounce bottle configured to hold the quantity of 3.2 ounces of the pesticide material in the concentrated form that is pre-measured for the 2-gallon tank of the handheld sprayer;
an 8-ounce bottle configured to hold the quantity of 8.0 ounces of the pesticide material in the concentrated form that is pre-measured for the 4-gallon or 5-gallon tank of the backpack sprayer; or
a 48-ounce or 60-ounce bottle configured to hold the quantity of 48.0-60.0 ounces of the pesticide material in the concentrated form that is pre-measured for the 4-gallon or 5-gallon tank of the backpack sprayer; and
wherein, the mixing the provided pre-measured single use concentrated pesticide product with the water in the tank of the applicator with the specific applicator tank size including:
mixing the 0.8 ounces of the pesticide material in the concentrated form from the 0.8-ounce bottle with the water in the ½-gallon tank of the handheld sprayer;
mixing the 1.6 ounces of the pesticide material in the concentrated form from the 1.6-ounce bottle with the water in the 1-gallon tank of the handheld sprayer;
mixing the 3.2 ounces of the pesticide material in the concentrated form from the 3.2-ounce bottle with the water in the 2-gallon tank of the handheld sprayer;
mixing the 8.0 ounces of the pesticide material in the concentrated form from the 8-ounce bottle with the water in the 4-gallon or 5-gallon tank of the backpack sprayer; or
mixing the 48.0-60.0 ounces of the pesticide material in the concentrated form from the 48-ounce or 60-ounce bottle with the water in the 30-gallon tank of the broadcast sprayer.
